(19) United States
(12) Patent Application Publication
(10) Pub. No.: US 2009/0034527 A1
(43) Pub. Date: Feb. 5, 2009

(54) Method of combating the sending of unsolicited voice information

(76) Inventors: Bertrand Mathieu, Pleumeur Bodou (FR); Yvon Gourhant, Lannion (FR); Quentin Loudier, Pleumeur Bodou (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/918,582

(22) PCT Filed: Apr. 10, 2006
(86) PCT No.: PCT/FR2006/050324

§ 371 Date: May 22, 2008

(30) Foreign Application Priority Data
Apr. 13, 2005 (FR) 0503710

(51) Int. Cl. H04L 12/56

(52) U.S. Cl. 370/392

(57) ABSTRACT

A method of combating the sending of unsolicited information in a packet transmission network from a sending entity to a destination entity, the unsolicited information being of voice type and being sent during a call that includes a call set-up stage during which a call signaling message is transmitted in the network, followed by an on-going call stage during which said unsolicited information is transmitted. The method includes a step of detecting unsolicited information during said call. The method also includes a reaction step triggered following detection of unsolicited information during the call. A system for combating the sending of unsolicited information is also disclosed.

The field of the invention is that of telecommunications. The invention relates more precisely to combating the sending of unsolicited information in the field of IP telephony, also known as voice over IP (VoIP) telephony.

The practice of sending unsolicited information to users is currently growing. When it is a question of sending electronic or e-mail messages, usually of a commercial kind, to users who have not requested them, the practice is called spam. Spam is recognized as being a real plague, the cause of significant losses of productivity to businesses. The practice is also growing in the field of instant messaging, where it is known as spim (from “spam on instant messaging”). The same practice can equally occur in the field of VoIP telephony, where it is known as spit (from “spam over Internet telephony”). The practice therefore impacts on users of Internet telephony applications. IP telephony is a voice communications technology that is growing fast and uses an IP data network to offer multimedia communications over a single voice and data network.

The sending of unsolicited information or spit in a VoIP network causes serious problems. Apart from users receiving unsolicited information, spit can lead to saturation of voice mailboxes associated with users or, in the worse case scenario, to a network equipment becoming unavailable following massive sending of messages. Sending spit that causes network equipment to become unavailable is known as a denial of service attack.

The spit may be sent either intentionally, or else unintentionally from a terminal that has been infected by a worm or a virus that is sending spit without the user of the terminal realizing it.

A need is therefore making itself felt to combat spit in order to protect users from receiving unsolicited information and to protect the network of an operator or an Internet service provider from overloads that can interfere with network availability.

At present there is no network level solution to combat spit. Spit is possible only in a VoIP infrastructure. This emerging infrastructure is beginning to be deployed and at present has few users. Few instances of spit have therefore been reported. Since the problems inherent to these instances being relatively minor for the time being, few studies have been carried out and very few solutions have been proposed.

The techniques used to combat spam cannot be applied directly. One example of a technique that is currently widely used to combat spam is to block undesirable electronic mail by using filters on messaging servers or client stations, after the mail is sent and before it is received. Filters can recognize keywords, and more sophisticated filters can, after a training stage, calculate the probability that a piece of electronic mail is spam on the basis of the keywords that it contains. Whatever the type of filter is used, that technique based on recognition of keywords is difficult to apply to voice messages. What is more, that technique does not prevent mail from circulating in the network.

An object of the present invention is to propose a method of detecting unsolicited voice information in a voice over IP telecommunications network. Another object of the invention is to propose a method including a reaction step following detection of spit. A further object of the invention is to provide technical means for collecting information relating to an entity identified as a source of spit and for offering a decontamination service should the terminal associated with that entity prove to have been infected by a worm or a virus that is sending spit unknown to the user of the terminal.

A first aspect of the invention is a method of combating the sending of unsolicited information in a packet transmission network from a sending entity to a destination entity, characterized in that the unsolicited information is of voice type and is sent during a call that includes a call set-up stage during which a call signaling message is transmitted in the network followed by an on-going call stage during which said unsolicited information is transmitted, and in that the method comprises:
a step of detecting unsolicited information during said call.

Detecting unsolicited information precedes a reaction. The advantage of the detection method lies in the fact that it is used in the call set-up stage and therefore before unsolicited information circulates in the network and reaches the target entity.

Unsolicited information is advantageously detected by analyzing the call signaling message coming from the sending entity and a call context relating to preceding calls coming from the sending entity.

Analyzing the call signaling message enables recovery of information relating to the call in the call set-up stage, for example information on the sending entity that is the source of the call. The analysis is effected in the network and has considerable advantages:
a malicious user who is the source of spit can be identified/located;
a terminal infected by a virus or a worm that is sending spit unknown to the user of the terminal can be identified/located;
because detection is effected in the network, the detection of spit is not conditional on a configuration specific to the user or the user's terminal;
a network operator obtains information about a user who is the source of spit, given that an operator may be legally required to disclose such information.

In a first implementation, unsolicited information is detected by counting over a time period a number of call signaling messages relating to a call in the call set-up stage and in comparing said number of call signaling messages to a threshold value that must not be exceeded.

Like making an ordinary telephone call, making a multimedia call involves a plurality of steps including dialing, ringing, picking up, conversation, or depositing a message in a voice mailbox. Said steps take time. The analysis mode corresponds to taking technical account of this delay: if a sending entity sends a plurality of calls simultaneously or within a short time window, then the sending of calls has been automated. In reality, although it can happen that a sending entity sends two successive calls to a destination entity, it is rare for it to send five or ten successive calls to the same destination entity.

In another implementation unsolicited information is detected by identifying over a time period automation logic in the composition of call's.

The advantage of this implementation is that it offers technical means in the network for detecting automatic scanning of a list of addresses used to make calls.

The method advantageously includes a reaction step triggered after the detection of unsolicited information during the call.

The reaction consists in blocking the call identified as sending unsolicited information, for example.

Instead of or in addition to this, the reaction consists in limiting the number of calls that can be sent per unit time by the entity sending unsolicited information.

Instead of or in addition to this, the reaction consists in redirecting to a network entity all or part of the call identified as sending unsolicited information.

The advantages of the reaction step are considerable and are of benefit both to users who are customers of a network operator and to the network operator itself:
spit does not circulate in the network;
users are not disturbed by unsolicited advertising messages;
the voice mailboxes of users are not saturated by unsolicited messages;
the operator improves the availability of its network equipment;
the operator protects its customers from spit and thereby strengthens its brand image;
finally, and more generally, the invention contributes to the expansion and propagation of VoIP technology by eliminating the impediment consisting of spit.

The method can advantageously offer a service for decontaminating a terminal associated with the sending entity that has been infected by a worm or a virus that is sending unsolicited information unknown to a user associated with the sending entity.

The invention also consists in a system for combating the sending of unsolicited information, the system comprising a packet transmission network, a sending entity, a destination entity, and an entity in the network, the system being characterized in that the unsolicited information is of voice type and is sent during a call that includes a call set-up stage during which a call signaling message is transmitted in the network, followed by an on-going call stage during which said unsolicited information is transmitted, and in that the entity in the network comprises:
a detection module adapted to detect the unsolicited information during said call.

The system advantageously includes a reaction module adapted to react following detection of the unsolicited information.

The invention further consists in a computer program adapted to be installed in a memory of a first entity of an IP transmission network, the program being characterized in that it includes instructions for managing a call context relating to calls sent by a sending entity, instructions for analyzing a call signaling message in the call set-up stage, and instructions for identifying the call as sending unsolicited information.

The computer program of the invention advantageously includes instructions for acting on calls coming from the sending entity and identified as sending unsolicited information.

Numerous details and advantages of the invention can be better understood on reading the description of one particular embodiment given with reference to the accompanying drawings, which are provided by way of non-limiting example and in which:

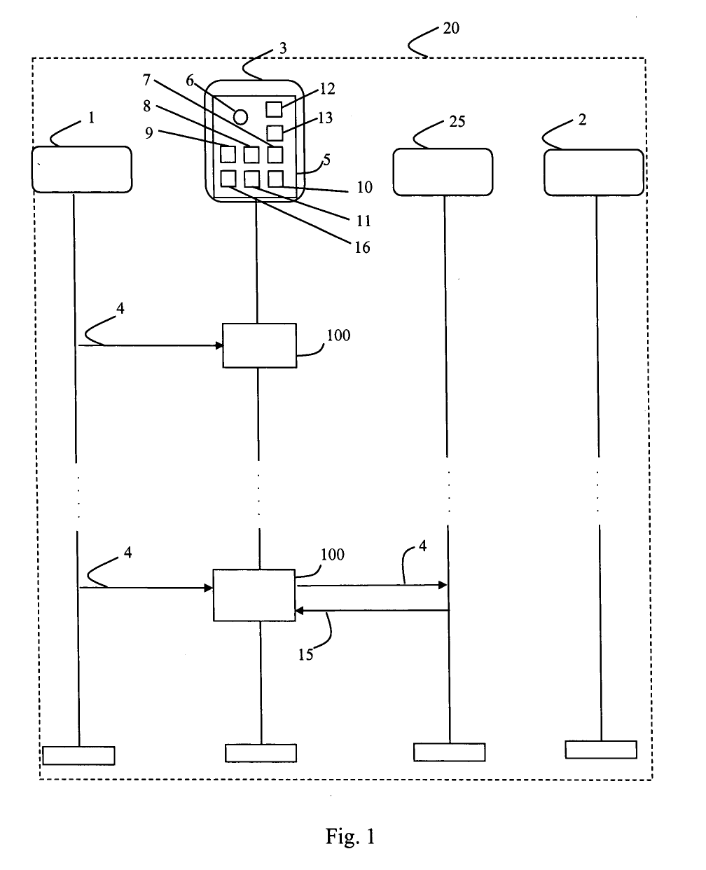

FIG. 1 illustrates a spit detection method based on a plurality of modes of analyzing SIP signaling messages exchanged during VoIP call set-up.

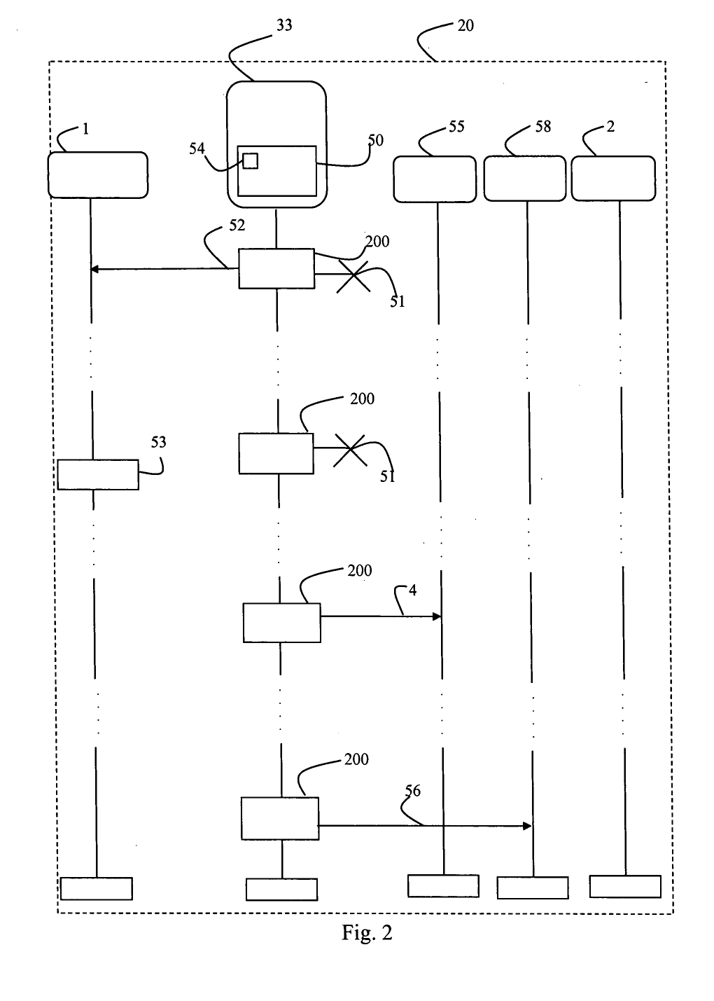

FIG. 2 illustrates a reaction method following detection of spit and based on a plurality of reaction modes.

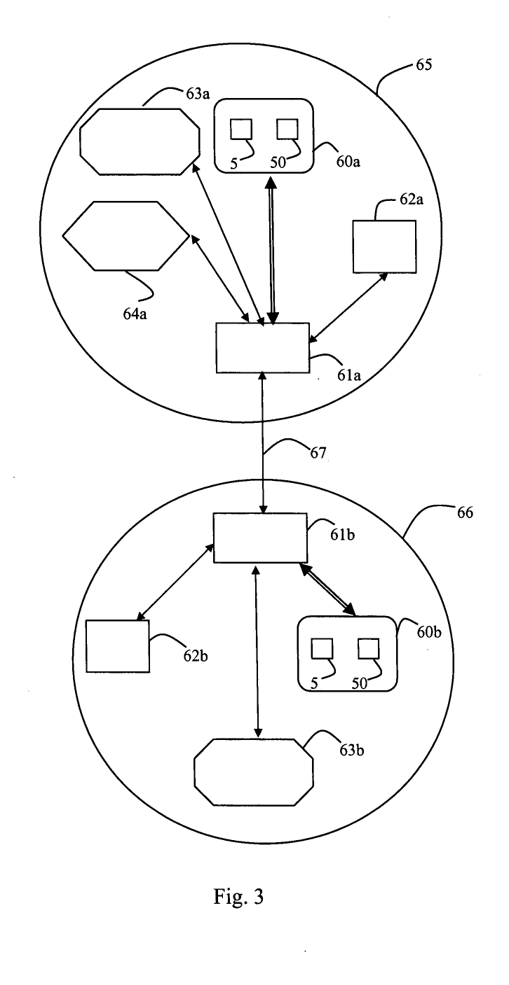

FIG. 3 shows an architecture corresponding to a first configuration of the invention in which the spit detection and reaction methods are implemented in application servers placed in an SIP-based VoIP network.

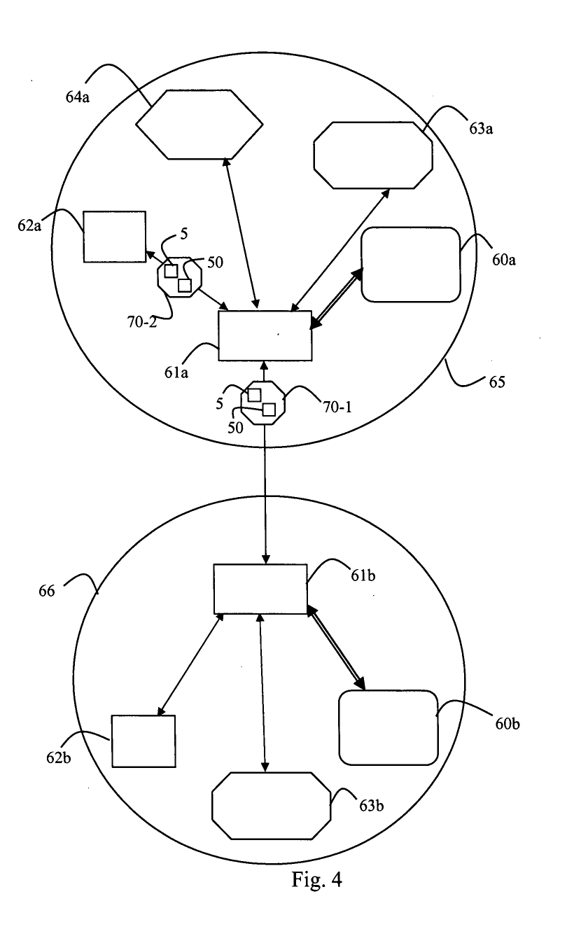

FIG. 4 shows an architecture corresponding to a second configuration of the invention in which the spit detection and reaction methods are implemented in application probes in the network.

The standards governing VoIP telephony include, for example, and non-exhaustively, the H.323 protocol from the ITU-T (International Telecommunications Union-Telecommunications standardization), see http://www.ietf.org/rfc/rfc3261.txt, and the Session Initiation Protocol (SIP) launched at the initiative of the IETF (Internet Engineering Task Force), see http://www.ietf.org. The signaling protocol SIP belongs to the application layer (layer 7) of the OSI (Open System Interconnection model). It relies on other protocols, for example, and non-exhaustively, RTP (Real Time Protocol), see http://www.ietf.org/rfc/rfc1890.txt, for transporting multimedia data in real time, and the Transmission Control Protocol (TCP) for transporting signaling. IP telephony, or to be more precise the signaling transmission part thereof, is also effected using a “peer to peer” (P2P) concept, which refers to a type of communication protocol having elements that do not play only client or only server roles but that operate in both these manners, being at one and the same time both clients and servers of other nodes of the network.

SIP manages multimedia calls on the basis of a client/server mode: messages exchanged during an SIP dialogue are enquiries or responses. SIP messages contain information relating to the call in progress, for example, and non-exhaustively, an identifier of the call, information relating to an entity sending the message in a field of the message called “FROM”, and information relating to a destination entity in a field of the message called “TO”. A response to an enquiry contains fields filled in identically to those of the enquiry, in particular the call identifier, the “FROM” field and the “TO” field. AN SIP response includes in particular a response state code that indicates how the enquiry was processed. The state code identifies a message received in response to an SIP enquiry as an error message or a success message. During an SIP dialogue, a multimedia call initiated by a sending entity that sends an enquiry and obtains no response is terminated by a TCP time-out mechanism implemented by TCP, on which SIP relies: a time-out that is set in the sending entity when sending the enquiry serves as a timer device, and the call is terminated if the time-out expires with no response to the enquiry.

The sending and destination entities involved in an SIP-based multimedia call are designated by addresses called URL SIP addresses (Uniform Resource Locator Session Initiation Protocol addresses) that identify a user and a terminal and that take the form: “user_information@domain”, where “user_information” corresponds to a name or a telephone number and “domain” corresponds to a domain name or an IP address. In a VoIP call, the user can be the calling or called party, as in an ordinary telephone call. The terminal can be a VoIP terminal, for example a personal digital assistant (PDA), a personal computer (PC) or an IP telephone.

A VoIP call uses an IP packet transmission network. Thus the network transmits both call signaling messages and data corresponding to information that the sending entity sends to the destination entity. Like an ordinary telephone call, a VoIP call proceeds through various stages, for example, and non-exhaustively, a call set-up stage during which the sending entity supplies the URL SIP address of the destination entity it wishes to contact, although the destination entity has not yet been informed that the sending entity wishes to contact it. In this stage, call signaling messages circulate in the network in order to reserve the resources necessary for the call and to determine if the destination entity is busy or free. In a stage after the call has been set up, the destination entity has been contacted either because it picked up when informed of the call or because a voice mailbox associated with the destination entity has been activated, behaving as if the destination entity had picked up. In the stage after the call has been set up, packets of data relating to a conversation that has been set up between the sending entity and the destination entity circulate in the network.

Referring to FIG. 1, a VoIP (voice over IP) type IP network 20 is responsible for VoIP call set-up. A sending entity 1 initiates a VoIP call to a destination entity 2. The sending and destination entities are considered to form integral parts of the network 20. A detection module 5 is installed in a first network entity 3 or in a remote machine that dialogues with a first entity 3 of the network 20. The detection module 5 is a program stored in a memory of the first network entity 3; it includes instructions for executing the detection method of the invention. The detection method 5 is triggered in a VoIP call set-up stage following reception by the first network entity 3 of an SIP call signaling message INVITE 4 corresponding to an invitation sent by the sending entity 1 to the destination entity 2 to participate in a multimedia call. The message includes information relating to the sending entity 1 in the “FROM” field and information relating to the destination entity 2 in the “TO” field. In a step 100, following activation of the detection module, the fields of the message 4 are analyzed. The analysis uses a call context 6 managed by the first network entity 3 that contains information relating to preceding messages received from the sending entity 1. The analysis identifies the current message as spit or not and is effected in four different modes described below. The detection module 5 implements at least one of the following four analysis modes:

In a first mode, the analysis is effected as follows: the detection module 5 counts SIP call signaling messages INVITE 4 coming from the sending entity 1. If, for a first time period 7 defined in the detection module 5, the number of SIP call signaling messages INVITE 4 received from the sending entity 1 exceeds a first threshold value 8 defined in the detection module 5, then it is considered that the sending of the call from the sending entity 1 was automated and that the messages coming from the sending entity 1 can be treated as spit. Automated call sending may optionally correspond to sending spit, in fact, because some entities can be authorized to automate sending messages. Said entities are listed in lists called white lists of entities authorized to send a plurality of calls simultaneously. Said entities are, for example, government agencies that send bulk alert or information messages. Bulk sending of messages by entities listed in white lists is not treated as spit. In this first embodiment, the call context managed by the network entity 3 contains a call identifier and a time stamp for each call sent by the sending entity 1.

In a second mode, the analysis is effected as follows: the detection module 5 counts successive calls from the sending entity 1 to the destination entity 2 during a second time period 9 defined in the detection module 5. If the number of calls exceeds a second threshold value 10 defined in the detection module 5, then it is considered that the sending of calls from the sending entity is automated and therefore that the messages coming from the terminal associated with the sending entity can be treated as spit. In this second mode the call context managed by the first network entity 3 contains at least a call identifier, a call time stamp and an identity of the destination entity 2 for each call sent by the sending entity 1.

In a third mode, the analysis is effected as follows: the detection module 5 detects the use of automation logic 11 in the manner of composing the destination addresses of VoIP calls sent by the sending entity 1 during a third time period 12 defined in the detection module 5. The use of automation logic corresponds, for example, to the use of sequential logic in the called user identities specified in the field “TO” of the SIP call signaling message INVITE 4, which can be chosen by scanning an alphabetical directory of user names. Another kind of automation logic is detected by detecting a constant call duration over a significant number of calls. In this third mode, the call context managed by the first network entity 3 contains at least a call identifier, a call time stamp and a URL SIP address of the destination entity 2 for each call sent by the sending entity 1.

In a fourth mode, the analysis is effected as follows: the detection module 5 counts during a fourth time period 13 defined in the detection module 5 the number of error messages 15 received by the first network entity 3 and coming from a VoIP routing element 25 of the network 20 following attempts to call destination entities that do not exist. Under such circumstances, the field “TO” of the SIP call signaling message INVITE 4 is filled but the information that appears there does not correspond to any entity that exists in the network 20. The fourth analysis mode therefore consists in counting a number of messages for which the state code corresponds to an error; if that number exceeds a third threshold value 16 defined in the detection module, it is then considered that the sending of the call from the sending entity is automated and therefore that messages coming from that entity can be treated as spit. In this fourth mode the call context managed by the first network entity 3 contains at least a call identifier and a call time stamp for each call sent by the sending entity 1 that fails.

The first, second, third and fourth time periods can be different or the same. Likewise, the first, second and third threshold values can be different or the same.

The four detection modes described above are independent. They may be used in a complementary manner (i.e. one mode is used alone or more than mode are used in combination).

By means of the analysis of the call signaling, the detection method provides technical means for identifying an entity that is sending spit either intentionally or unintentionally because a virus or a worm has infected the terminal that is associated with the entity and is sending spit unknown to the user of the terminal. Information that identifies an entity that is sending spit facilitates possible subsequent legal action if it proves that the users associated with the entities are sending spit knowingly or enables a decontamination service to be offered if the terminal associated with the entity has been infected by a worm or a virus.

Referring to FIG. 2, a spit reaction module 50 is implemented in a second network entity 33 of the network 20. Alternatively, the reaction module 50 is implemented in a remote machine that dialogues with the second network entity 33 of the network 20. The reaction module 50 is a program stored in a memory of the second network entity 33; it includes instructions for executing the reaction method of the invention. The reaction module 50 is triggered following detection of spit by a detection module 5, as described with reference to FIG. 1. The detection module 5 and the reaction module 50 of the present invention are independent in the sense that detection of spit by an entity or a module other than that described in the context of the invention can trigger the reaction module. In one specific embodiment, the modules 50 and 5 are implemented in the same network entity.

One or more reaction modes are implemented in a step 200, following triggering of the reaction module 50. The reaction module 50 implements at least one of the following reaction modes:
In a first reaction mode, calls initiated by the sending entity 1, identified by the detection module as the source of spit, are blocked 51. The SIP call signaling message INVITE received from the sending entity is not routed by the network 20. In a first embodiment, the reaction module 50 sends an information message 52 to the sending entity 1 informing it that it is impossible to contact the destination entity 2. In a second embodiment, the reaction module 50 sends nothing to the sending entity 1. Under such circumstances, the call is terminated in a step 53 by a TCP time-out mechanism.

In a second reaction mode, the number of calls that the sending entity 1 is authorized to send per unit time is limited to a value 54 defined in the reaction module 50. The value 54 can be a parameter set temporarily or permanently. When the number of calls initiated by the sending entity 1 reaches the value 54, a new call initiated by the sending entity 1 is processed according to one of the other reaction modes.

In a third reaction mode, the call initiated by the sending entity 1 can be redirected to a network entity 55 of the network 20 that either executes a call processing automaton or routes the call to a VoIP support service dedicated to processing this kind of problem. The automaton or the service can, by way of non-limiting example:
indicate to the sending entity 1a problem in the composition of calls;
inform the sending entity 1 of a suspicious activity of the associated terminal and propose that it be connected to the support service to solve the problem;
propose to the sending entity 1 that it files a complaint if it thinks that this is an error;
begin any other communication action enabling the spit to be terminated whilst preserving the relation with the user associated with the sending entity 1.

In a fourth reaction mode, an event 56 associated with the spit identified by the detection module 50 is routed to a network entity 58 responsible for call supervision operations in the network 20. The network entity 58 can host the information system (SI) of the network 20, an after-sales service (SAV) or a VoIP support service. Routing the event 56 to the network entity 58 means that more all-embracing actions can be envisaged, over and above repeating the same operations on each call passed:
For example, the sending entity is placed in a call restriction category, i.e. is authorized to call only emergency services, the SAV service or the VoIP service, or to make only local calls.
For example, the sending entity is placed under surveillance, with a view to providing proof that a network operator might legally be required to produce. Surveillance consists, for example, in logging calls sent and communication parameters such as call durations.
For example, coordinates of the user associated with the sending entity are recovered in order to send to the user mail summarizing calls suspected of constituting spit and proposing connection to a service capable of proposing solutions before placing the user in a call restriction category.

The reaction module 50 is advantageously extended in order to track a user profile associated with more or less spam, to obtain and keep up to date statistics specific to spit, relying on the evolution of user profiles to group together users sending spit with equivalent profiles within common categories enabling identical processing to be applied for a set of client users belonging to the same category. This enables correlation of calls and detection of changed behavior, so that lists of users who send spit can be defined, which lists are also known as black lists, or indicates that a user whose behavior has until now been normal is now sending spit. Under such circumstances, the user's terminal may have been infected by a virus or a worm and be sending spit unknown to the user. Thus it is possible to detect that terminals have been infected and to offer a service for decontaminating the terminals. In exactly the same way, there can be white lists of persons authorized to send simultaneous calls, such as government departments. Under such circumstances, spit detection counters can advantageously be correlated with the white lists before taking decisions to block calls.

In a first embodiment of the invention, shown in FIG. 3, spit detection and reaction modules are implemented in an SIP application server in the form of value-added or sophisticated services. Referring to FIG. 3, a VoIP network architecture based on the SIP and integrating the spit detection module 5 and the spit reaction module 50 in application servers 60a and 60b, respectively, is described. This embodiment is advantageously used to detect spit and to react in the context of a VoIP network architecture deployed by a network operator with network routing elements. Said routing elements can be SIP delegated servers (often referred to as “SIP proxies”) 61a and 61b, respectively, to which servers sending or destination entities or SIP clients 62a and 62b, respectively, are connected.

Said SIP proxy servers route calls in the SIP network. The invention is illustrated in an SIP-based architecture and applies equally to an architecture based on the H.323 protocol, because said protocol uses the same functional components, for example, and, non-exhaustively, H.323 access controllers (“gatekeepers”), which are network elements whose role is to set up a call between a sending entity and a destination entity and to set up the routing in the same way as a routing element of an SIP-based architecture.

An SIP call is set up between two SIP clients 62a and 62b via SIP proxy servers 61a and 62b, respectively, which are responsible for routing calls in the VoIP network. The architecture can encompass SIP location servers 63a and 63b for supplying the current position of the users and SIP registration servers 64a and 64b for registering clients of a domain 65 or 66 in a database. The SIP proxy servers 61a and 61b may need to communicate with each other, as indicated by the arrow 67, if the SIP clients are connected to different SIP proxy servers 61a and 61b. This applies if a call is set up between two SIP clients 62a and 62b belonging to different domains 65, 66.

Said application servers can be located close to SIP proxy servers, as illustrated in FIG. 3. In other VoIP architecture implementations, an application server can be connected to a plurality of SIP proxy servers or a plurality of application servers can be connected to one SIP proxy server if it is a question of implementing a plurality of value-added service logics or applying load sharing. Said application servers can access all the call signaling parameters, modify them, redirect calls and interact with other modules. It is therefore easy to implement a value-added service on an SIP architecture. To provide value-added services, software modules executed in application servers are added to the architecture.

Various options are available for integrating value added services into a VoIP architecture:
a CPL (call processing language) standard is used to integrated value-added services above an SIP proxy server.
interfaces have been defined for developing value-added services on application servers: an OSA (Open Service Access)/parlay interface that is covered by a standard defined by the European Telecommunications Standards Institute (ETSI) and based on an OSA architecture, see http://www.parlay.org/specs/index.asp, enables services to use network functions by means of standardized interfaces, and an OSA/Parlay X interface that is also covered by a standard defined by ETSI, see http://www.parlay.org/specs/index.asp, is based on web services and offers important advantages: it tends to dispense with knowledge of the telecommunication networks and is an industrial standard that offers independence of execution platforms.

The invention described here applies whichever interface is used, CPL above an SIP proxy server, OSA/parlay or OSA/Parlay X at the level of an application server. It in fact suffices to have software modules integrated into the architecture that implement the spit detection and reaction modules as described above. The integration of said modules can be effected via a value-added service installed on an application server or more generically via a component enabling the development of services. It can also be integrated directly into the SIP proxy server, for example using CPL.

The invention applies to any type of architecture supporting multimedia services and offering standardized interfaces. For example, in another embodiment of the invention, an application server according to the invention is installed in an IMS (Internet Protocol Multimedia Subsystem) type architecture, a standard originating from the 3GPP (Third Generation Partnership Project), see http://www.3gpp.org.

In this second embodiment of the invention, shown in FIG. 4, the spit detection module 5 and the reaction module 50 are implemented in application probes 70-1 and 70-2, respectively, placed in the network. Application probes are equipments placed in the network of a telecommunication operator or an Internet service provider that in real time identify each stream, analyze the stream up to the application level, and transparently, that is to say without the users or the terminals knowing that the stream has been analyzed, and intercept all packets of the data streams. The application probes are described as passive if their action is limited to watching the stream pass without acting on it. Passive probes can analyze the stream in real time and store data relating to said streams in a file with a view to analyzing it subsequently. The data is, for example, and non-exhaustively, a number of data items exchanged, a number of connections set up, a type of stream. The subsequent analysis of the data can be used to understand the functioning of the network, analyze the behavior of users, classify users into categories. Passive probes are advantageously used when no reaction follows detection of spit. However, if passive probes are capable of exporting to external entities data such as addresses of terminals suspected of sending spit, then the external entities can use deferred reaction mechanisms, consisting for example in routing to a voice server all calls sent by a terminal suspected of sending spit. The application probes can equally act on the stream. Under such circumstances, they are referred to as active application probes. By way of non-limiting example, if IP telephony is implemented in a P2P technology, the active application probe can act on the PSP stream. This is relevant to the invention if the PSP protocol provides a VoIP function. In a VoIP network based on standard protocols, such as SIP, a multimedia session consists of two streams, one stream that corresponds to all SIP signaling messages and one stream that corresponds to data conveyed by the RTP (Real Time Protocol). The SIP signaling, identified by the active application probe, can then be analyzed with a view to detecting spit in the same way as in a spit detection module as described above installed in an SIP proxy server or an application server: call signaling fields are analyzed as a function of a stored call context, and the call is identified as spit or not. An active application probe can also act on said streams, especially if they are treated as spit, in the same way as in a spit reaction module as described above installed in a spit proxy or an application server: either by doing nothing and allowing the call to pass or by redirecting them to a VoIP network entity that executes a call processing automaton or that routes said streams to a support service dedicated to this type of problem, either blocking them or limiting the number of calls that can be sent per unit time by the calling unit, or feeding back events making it possible to envisage more all-encompassing operations such as placing the calling entity in a call restriction category. In another embodiment of the invention, the RTP stream identified by the active application probe can advantageously be analyzed to detect spit. Detecting spit from RTP streams is effected by recognizing common characteristics in the payload of the packets, corresponding to data, of different RTP packets indicating that the same data item is circulating more than once in the network. For example, the recognition of common characteristics can consist in identifying the same signature in RTP data packets or the same data packet size, indicating that data items of the same size are circulating in the network (this example does not limit the invention). A correlation is effected between the opening of an RTP session for the transport of data and the SIP signaling. The information supplied by said SIP signaling then enables the probe to react to the detection of spit in the same way as in the reaction module described above.

The active application probes can be placed at different locations in the VoIP network, as shown in FIG. 4. Said probes 70-1 and 70-2 are installed between an SIP client 62a and an SIP proxy server 61a or between two SIP proxy servers 61a and 61b.

This embodiment of the invention adds spit detection and reaction modules to the active application probes.

This embodiment is of considerable advantage: it enables detection of VoIP calls in transit in a VoIP architecture of an operator based on various protocols: for example SIP or H.323, but also VoIP calls using the peer-to-peer technology.

1. A method of combating the sending of unsolicited information in a packet transmission network (20) from a sending entity (1) to a destination entity (2), the unsolicited information being of voice type and being sent during a call that includes a call set-up stage during which a call signaling message is transmitted in the network followed by an on-going call stage during which said unsolicited information is transmitted, wherein the method comprises:
a step (100) of detecting unsolicited information during said call.

2. The method according to claim 1, wherein unsolicited information is detected by analyzing the call signaling message (4) coming from the sending entity and a call context (6) relating to preceding calls coming from the sending entity.

3. The method according to claim 2, wherein unsolicited information is detected by counting over a time period (7, 9) a number of call signaling messages relating to a call in the call set-up stage and comparing said number of call signaling messages to a threshold value (8, 10) that must not be exceeded.

4. The method according to claim 2, wherein unsolicited information is detected by identifying over a time period (12) automation logic (11) in the composition of calls.

5. The method according to claim 1, wherein unsolicited information is detected by recognizing common characteristics in packets transmitted in the stage after the call has been set up.

6. The method according to claim 1, comprising a reaction step triggered after detection of unsolicited information during a call.

7. The method according to claim 6, wherein the reaction includes blocking (51) a call identified as sending unsolicited information.

8. The method according to claim 6, wherein the reaction includes limiting the number of calls that can be sent per unit time by the entity (1) sending unsolicited information.

9. The method according to claim 6, wherein the reaction includes redirecting to a network entity (55, 58) all (4) or part (56) of a call identified as sending unsolicited information.

10. The method according to claim 1, further comprising decontaminating a terminal associated with the sending entity that has been infected by a worm or a virus and is sending unsolicited information unknown to a user associated with the sending entity.

11. A system for combating the sending of unsolicited information, the system comprising a packet transmission network (20), a sending entity (1), a destination entity (2), and an entity (3, 33) in the network, the unsolicited information being of voice type and being sent during a call that includes a call set-up stage during which a call signaling message is transmitted in the network followed by an on-going call stage during which said unsolicited information is transmitted, wherein the entity in the network comprises:
a detection module (5) adapted to detect unsolicited information during said call.

12. The system according to claim 11 wherein the entity (3, 33) in the network includes a reaction module (50) adapted to react following detection of unsolicited information.

13. The system according to claim 11 wherein the detection module (5) analyses the call signaling message and a call context (6) relating to preceding calls coming from the sending entity.

14. A computer program adapted to be installed in a memory of an entity (3, 33) of a packet transmission network, the program comprising instructions for managing a call context relating to calls sent by a sending entity, instructions for analyzing a call signaling message in the call set-up stage, and instructions for identifying a call as sending unsolicited information.

15. The computer program according to claim 14 adapted to be installed in a memory of the entity (3, 33) of the packet transmission network, the program comprising instructions for acting on calls coming from the sending entity and identified as sending unsolicited information
